(19) United States
(12) Patent Application Publication
(10) Pub. No.: US 2011/0145094 A1
(43) Pub. Date: Jun. 16, 2011

(54) CLOUD SERVICING BROKERING

(75) Inventors: Christopher J. Dawson, Arlington, VA (US); Vincenzo V. Diluoffo, Sandy Hook, CT (US); Michael D. Kendzierski, New York, NY (US); James W. Seaman, Falls Church, VA (US)

(73) Assignee: International Business Machines Corporation, Armonk, NY (US)

(21) Appl. No.: 12/636,668

(22) Filed: Dec. 11, 2009

(51) Int. Cl. G06Q 30/00; G06F 17/30

(52) U.S. Cl. 705/26.63; 707/770; 707/E17.014

(57) ABSTRACT

The present invention provides a solution to perform pricing and brokering of Cloud services. Illustrative pricing/charging plans include “pay as you go (subscription)” and “pay for what you use (dynamic)”. The present invention also provides a way to display a price next to service. In general, a broker agent (hereinafter referred to as “agent”) executes within the environment and queries available and acceptable Cloud resources from a plurality of providers. Based on resources, published rates, and rate projections, the broker schedules, reschedules, moves, and otherwise manages Cloud jobs based on job criteria and optimized execution cost.

### FIELD OF THE INVENTION

In general, the present invention relates to Cloud computing. Specifically, the present invention relates to the brokering of Cloud services within a Cloud computing environment.

### BACKGROUND OF THE INVENTION

Cloud computing has become a popular way to offer various Information Technology (IT) concepts as services. In one implementation, a user can request a service they desire and transact with a Cloud provider for the needed service. A Cloud service user's business opportunity can be limited or constrained by the physical resources providers have installed, or by their capacity to procure resources in a timely and cost-efficient manner. Given that many Cloud service providers could be capable of providing similar services, identifying the Service provider that best meets the needs of a user (e.g., priced, scheduling, etc.) can be difficult.

### SUMMARY OF THE INVENTION

The present invention provides a solution to perform pricing and brokering of Cloud services. Illustrative pricing/charging plans include “pay as you go (subscription)” and “pay for what you use (dynamic)”. The present invention also provides a way to display a price next to service. In general, a broker agent (hereinafter referred to as “agent”) executes within the environment and queries available and acceptable Cloud resources from a plurality of providers. Based on resources, published rates, and rate projections, the broker schedules, reschedules, moves, and otherwise manages Cloud jobs based on job criteria and optimized execution cost.

A first aspect of the present invention provides a method for brokering Cloud services within a Cloud computing environment, comprising: receiving a request for a Cloud service from a user; identifying a set of Cloud service providers capable of providing the Cloud service based upon criteria established by the user, the criteria comprising a desired price for obtaining the Cloud service; and communicating with a specific Cloud service provider from the set of Cloud service providers to provide the Cloud service at the desired price.

A second aspect of the present invention provides a system for brokering Cloud services within a Cloud computing environment, comprising: a memory medium comprising instructions; a bus coupled to the memory medium; a processor coupled to the bus that when executing the instructions causes the system to: receive a request for a Cloud service from a user; identify a set of Cloud service providers capable of providing the Cloud service based upon criteria established by the user, the criteria comprising a desired price for obtaining the Cloud service; and communicate with a specific Cloud service provider from the set of Cloud service providers to provide the Cloud service at the desired price.

A third aspect of the present invention provides a computer readable medium containing a program product for brokering Cloud services within a Cloud computing environment, the computer readable medium comprising program code for causing a computer to: receive a request for a Cloud service from a user; identify a set of Cloud service providers capable of providing the Cloud service based upon criteria established by the user, the criteria comprising a desired price for obtaining the Cloud service; and communicate with a specific Cloud service provider from the set of Cloud service providers to provide the Cloud service at the desired price.

A fourth aspect of the present invention provides a method for deploying a system for brokering Cloud services within a Cloud computing environment, comprising: providing a computer infrastructure being operable to: receive a request for a Cloud service from a user; identify a set of Cloud service providers capable of providing the Cloud service based upon criteria established by the user, the criteria comprising a desired price for obtaining the Cloud service; and communicate with a specific Cloud service provider from the set of Cloud service providers to provide the Cloud service at the desired price.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a Cloud system node according to the present invention.

FIG. 2 shows a Cloud computing environment according to the present invention.

FIG. 3 shows Cloud abstraction model layers according to the present invention.

FIG. 4 shows an illustrative diagram that depicts the brokering of Cloud services according to the present invention.

FIG. 5 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. Cloud Computing Definitions

II. Implementation of the Invention

### I. Cloud Computing Definitions

The following definitions have been derived from the “Draft NIST Working Definition of Cloud Computing” by Peter Mell and Tim Grance, dated Oct. 7, 2009, which is cited on an IDS filed herewith, and a copy of which is attached thereto.

Cloud computing is a model for enabling convenient, on-demand network access to a shared pool of configurable computing resources (e.g., networks, servers, storage, applications, and services) that can be rapidly provisioned and released with minimal management effort or service provider interaction. This Cloud model promotes availability and is comprised of at least five characteristics, at least three service models, and at least four deployment models.

Characteristics are as follows:

On-demand self-service: A consumer can unilaterally provision computing capabilities, such as server time and network storage, as needed, automatically without requiring human interaction with each service's provider.

Broad network access: Capabilities are available over a network and accessed through standard mechanisms that promote use by heterogeneous thin or thick client platforms (e.g., mobile phones, laptops, and PDAs).

Resource pooling: The provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, network bandwidth, and virtual machines.

Rapid elasticity: Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Cloud Software as a Service (SaaS): The capability provided to the consumer is to use the provider's applications running on a Cloud infrastructure. The applications are accessible from various client devices through a thin client interface such as a web browser (e.g., web-based email). The consumer does not manage or control the underlying Cloud infrastructure including network, servers, operating systems, storage, or even individual application capabilities, with the possible exception of limited user-specific application configuration settings.

Cloud Platform as a Service (PaaS): The capability provided to the consumer is to deploy onto the Cloud infrastructure consumer-created or acquired applications created using programming languages and tools supported by the provider. The consumer does not manage or control the underlying Cloud infrastructure including networks, servers, operating systems, or storage, but has control over the deployed applications and possibly application hosting environment configurations.

Cloud Infrastructure as a Service (IaaS): The capability provided to the consumer is to provision processing, storage, networks, and other fundamental computing resources where the consumer is able to deploy and run arbitrary software, which can include operating systems and applications. The consumer does not manage or control the underlying Cloud infrastructure but has control over operating systems, storage, deployed applications, and possibly limited control of select networking components (e.g., host firewalls).

Deployment Models also known as “Cloud implementations” or “Cloud types”) are as follows:

Private cloud: The Cloud infrastructure is operated solely for an organization. It may be managed by the organization or a third party and may exist on-premises or off-premises.

Community cloud: The Cloud infrastructure is shared by several organizations and supports a specific community that has shared concerns (e.g., mission, security requirements, policy, and compliance considerations). It may be managed by the organizations or a third party and may exist on-premises or off-premises.

Public cloud: The Cloud infrastructure is made available to the general public or a large industry group and is owned by an organization selling Cloud services.

Hybrid cloud: The Cloud infrastructure is a composition of two or more clouds (private, community, or public) that remain unique entities but are bound together by standardized or proprietary technology that enables data and application portability (e.g., Cloud bursting for load-balancing between clouds).

A Cloud computing environment is service oriented with a focus on statelessness, low coupling, modularity, and semantic interoperability.

### II. Implementation of the Invention

The present invention provides a solution to perform pricing and brokering of Cloud services. Illustrative pricing/charging plans include pay as you go (subscription)” and “pay for what you use (dynamic)”. The present invention also provides a way to display price next to service. In general, a broker agent (hereinafter referred to as “broker”) executes within the environment and queries available and acceptable Cloud resources from a plurality of providers. Based on resources, published rates, and rate projections, the broker schedules, reschedules, moves, and otherwise manages Cloud jobs based on job criteria and optimized execution cost.

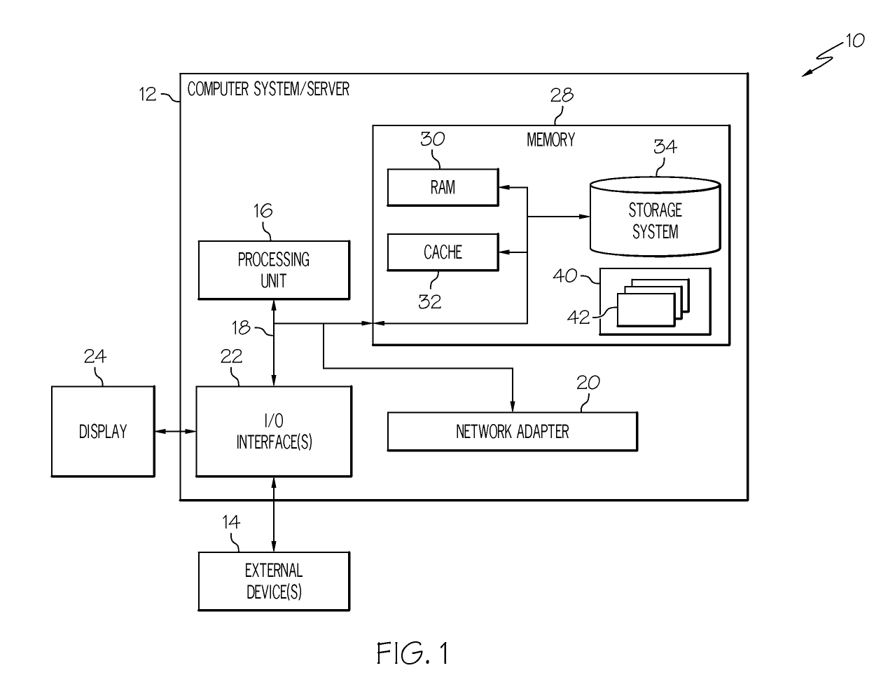

Referring now to FIG. 1, a schematic of an exemplary Cloud computing node is shown. Cloud computing node 10 is only one example of a suitable Cloud computing node and is not intended to suggest any limitation as to the scope of use or functionality of the invention described herein. Regardless, Cloud computing node 10 is capable of being implemented and/or performing any of the functions set forth in Section I above.

In Cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed Cloud computing environments that include any of the above systems or devices, and the like.

Computer system/server 12 may be described in the general context of computer system-executable instructions, such as program modules, being executed by a computer system. Generally, program modules include routines, programs, objects, components, logic, data structures, and so on, that perform particular tasks or implement particular abstract data types. The exemplary computer system/server 12 may be practiced in distributed Cloud computing environments where tasks are performed by remote processing devices that are linked through a communications network. In a distributed Cloud computing environment, program modules may be located in both local and remote computer system storage media including memory storage devices.

As shown in FIG. 1, computer system/server 12 in Cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, a storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of the invention.

Program/utility 40 having a set (at least one) of program modules 42 may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of the invention as described herein.

Computer system/server 12 may also communicate with one or more external devices 14 such as a keyboard, a pointing device, or a display 24, etc., one or more devices that enable a user to interact with computer system/server 12, and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

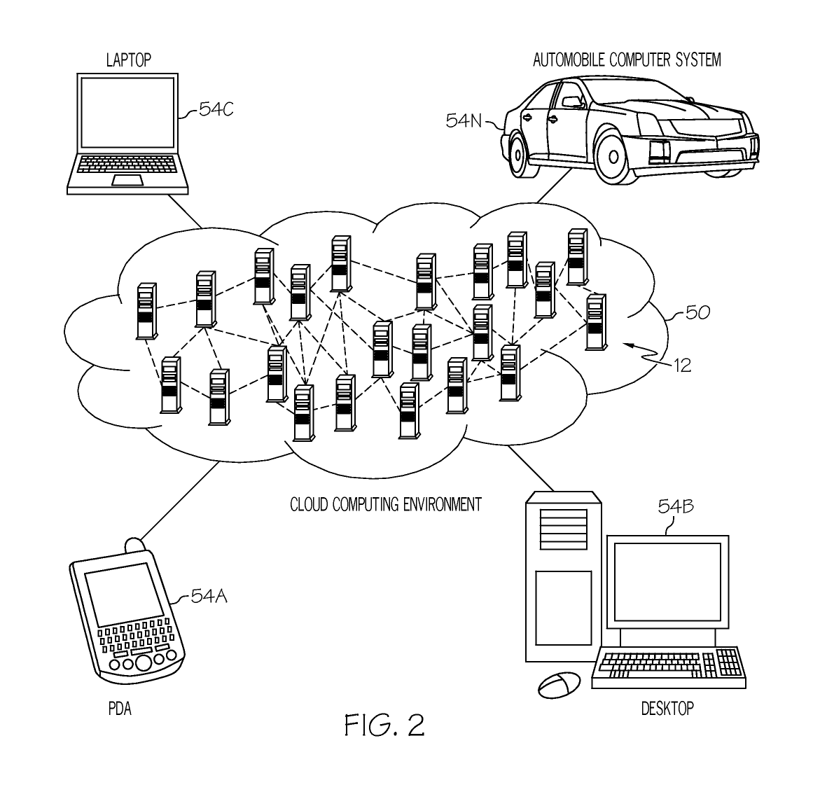

Referring now to FIG. 2, illustrative Cloud computing environment 50 is depicted. As shown, Cloud computing environment 50 comprises one or more Cloud computing nodes 10 with which computing devices such as, for example, personal digital assistant (PDA) or cellular telephone 54A, desktop computer 54B, laptop computer 54C, and/or automobile computer system 54N communicate. This allows for infrastructure, platforms and/or software to be offered as services (as described above in Section I) from Cloud computing environment 50, so as to not require each client to separately maintain such resources. It is understood that the types of computing devices 54A-N shown in FIG. 2 are intended to be illustrative only and that Cloud computing environment 50 can communicate with any type of computerized device over any type of network and/or network/addressable connection (e.g., using a web browser).

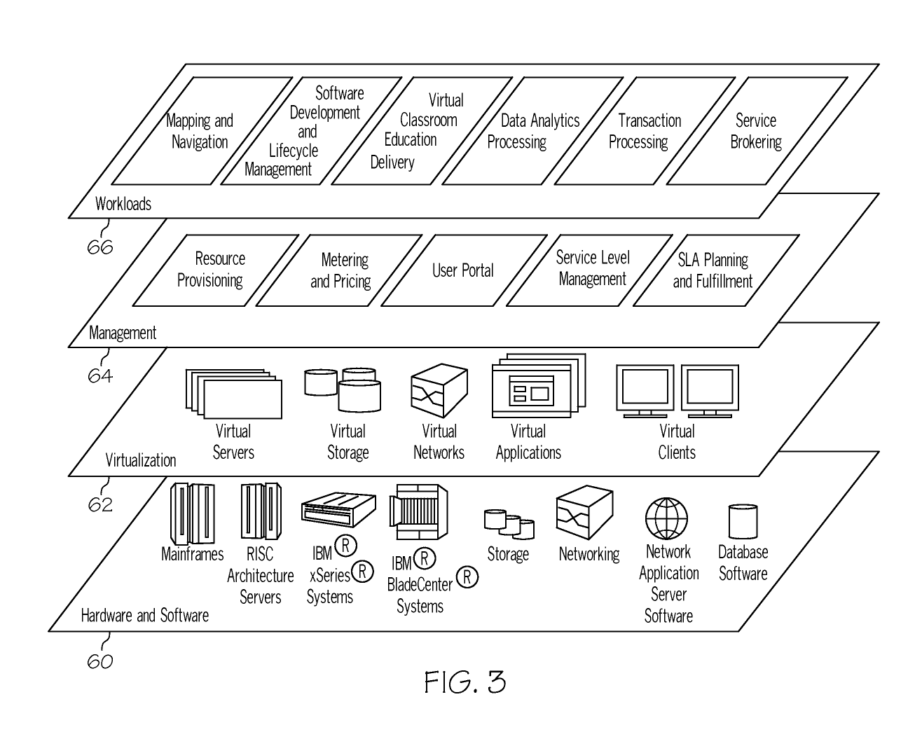

Referring now to FIG. 3, a set of functional abstraction layers provided by Cloud computing environment 50 (FIG. 2) is shown. It should be understood in advance that the components, layers, and functions shown in FIG. 3 are intended to be illustrative only, and the invention is not limited thereto. As depicted, the following layers and corresponding functions are provided:

Hardware and software layer 60 includes hardware and software components. Examples of hardware components include mainframes. In one example, IBM® zSeries® systems, and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software, and database software. In one example, IBM DB2® database software. (IBM, zSeries, pSeries, xSeries, BladeCenter, WebSphere, and DB2 are trademarks of International Business Machines Corporation in the United States, other countries, or both.)

Virtualization layer 62 provides an abstraction layer from which the following exemplary virtual entities may be provided: virtual servers; virtual storage; virtual networks, including virtual private networks; virtual applications; and virtual clients.

Management layer 64 provides the exemplary functions described below. Resource provisioning provides dynamic procurement of computing resources and other resources that are utilized to perform tasks within the Cloud computing environment. Metering and pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that required service levels are met. Service Level Agreement (SLA) planning and fulfillment provides pre-arrangement for, and procurement of, Cloud computing resources for which a future requirement is anticipated in accordance with an SLA.

Workloads layer 66 provides functionality for which the Cloud computing environment is utilized. Examples of workloads and functions which may be provided from this layer include: mapping and navigation; software development and lifecycle management; virtual classroom education delivery; data analytics processing; transaction processing; and service brokering.

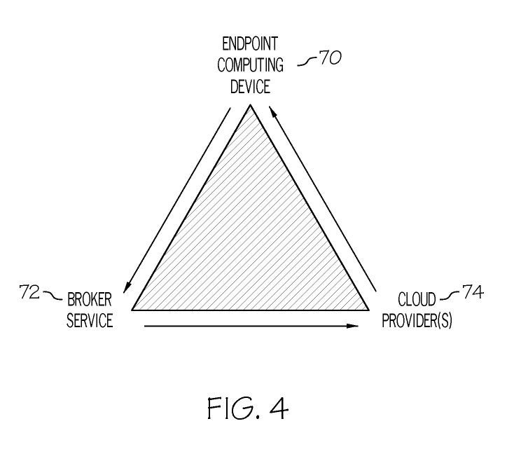

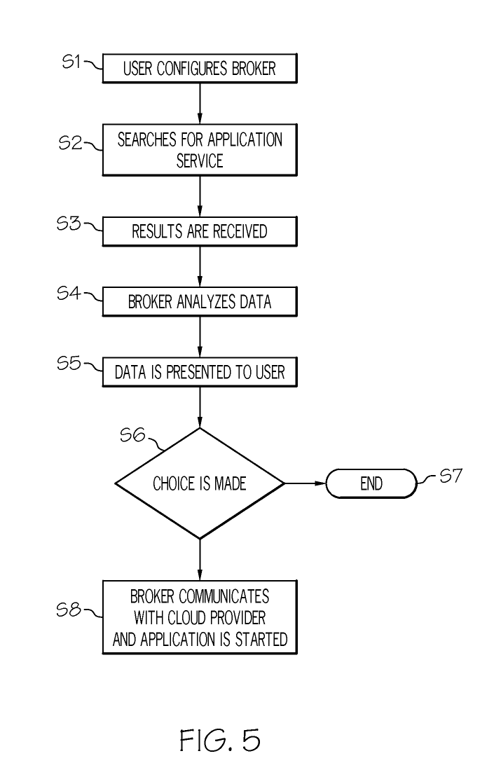

Cloud service brokering functionality generally implements the teachings of the present invention. To this extent, service brokering function(s) can be implemented as hardware, software (e.g., program modules 42 of utility/program 40), or a combination thereof. Regardless, the service registration functions of the present invention will be further described in conjunction with FIGS. 4 and 5, as well as the illustrative examples set forth below.

### ILLUSTRATIVE EXAMPLE

Consider a Cloud service being offered for document writing. The client selects this service. It has a one-time cost for provisioning and an ongoing cost of $1 a minute. The price may be displayed next to the service catalog and constantly updated on the screen. The costs of the service provided by multiple suppliers may also be included (so that a client can see competing prices of competitor Cloud providers).

The present invention leverages this competitive environment and uses an “intelligent” broker to determine where and when to execute each job. In an example, a job may be submitted to “Cloud A”, which is the lowest cost provider at the time of submission. The broker may then determine that a different Cloud is currently offering an even lower cost execution environment. An assessment is then completed by the broker in order to determine whether or not a relocation of the job will provide a savings to the customer/user that justifies such a relocation. For example, if the cost of relocating the job would exceed the savings, the relocation would not be recommended. Similarly, if the savings did not exceed the cost of relocation by more than a predetermined threshold (e.g., as set by the user), then relocation would similarly not be recommended.

Referring to FIG. 4, an illustrative diagram depicting the brokering of Cloud services according to the present invention is shown. As shown, an endpoint computing device 70 (operated by a user) communicates via a broker 72 to purchase/obtain Cloud services from one or more Cloud providers 74.

The concept of broker 72 running within the endpoint computing device or as a service in a Cloud can be leveraged in both configuration as one gives a 1 to N relationship at the endpoint while at the Cloud there is an N to N relationship and levels of scalability become factors. The broker 72 provides the capability to channel data from source to destination, so that a request can obtain a response in an asynchronous manner. An arbitrator (logic) must be built into a broker in order to analyze the data and make decisions on parameter-based configurations. This means that similar to stock market of buying and selling, the same set of logic could be integrated into application services (e.g., short, long, and spot).

There are a set of elements that implement the invention for brokering (i.e., pricing and charging) of Cloud services. These elements are broken down into a pricing taxonomy, arbitrator and where a broker may reside. In order for prices on application services to be presented to a customer and dynamically updateable, a new taxonomy can be created. The Cloud environment provides a dynamic capability, so that real-time changes can be made to the taxonomy.

In order for Cloud service providers to share pricing, promotional information, and specials, a number of additional fields must be appended to the description field. Within services, a number of factors can contribute into the price such as: the time the service is being required (peak time vs. off-peak), the block of usage with a period of time, and volume usage. These combined elements allow one to adjust the pricing data frequently. This also plays into the competition of Cloud providers providing the cheapest cost.

In order for pricing information to be presented to the user with options, the description field+pricing fields #1+option description+pricing field #2+option description+pricing field #N+option description should be part of the catalog taxonomy. The pricing fields would house the options associated with the application service like peak hours 8 a.m. to 2 p.m. EST are $2 for every hour used and off peak would drop down to $1. Another example would be for every 10 usages or more than 10 paid hours of this application service, a $5 deduction would be taken off the total bill. The new taxonomy provides a mechanism to display multiple options to the end user.

The data can be shared in a meaningful way between entities (i.e., endpoint, services broker, and Cloud provider), as described above for pricing. The present invention provides a mechanism to analyze the data and make decisions about if one deal is better than the other and which provider is providing the best price for the service. The logic of an arbitrator becomes an important concept for dealing with a number of options/offerings. From a user's perspective, the arbitrator should be readily configurable module where setting a number of parameters will set low and high value levels for making decisions about the price or option for the selected application service.

For example, the arbitrator logic would analyze data that would be returned from a search about an application service for a document editing tool. Cloud provider 1 can offer the tool for $1/hr at peak hours and Cloud 2 can provide at $1.5/hr at peak, but will provide a rebate of $3 for 4 hours of usage. The user will need 4 hours of time. The arbitrator will make the choice on the user preferences that were set up before the search was conducted about the application. The user set the price field for $3.5 max and 0.50 low. Since Cloud provider 2 was the cheapest at $3, the arbitrator displayed that provider for the application. A number of other scenarios can be presented, but the arbitrator logic would need to analyze these different data sets and make the best decision.

The broker function can reside in the user computing environment or in the Cloud as a service. The broker function sends/receives data messages to/from the Cloud provider. These data messages are the search queries for the applications, and results are matched to the queries sent. If the broker resides in the user environment, there is one user and one request for many responses, so that when a user wants a document editing tool for $3 for 4 hrs that query may end up at Cloud provider 1, 2 and 3. Each one will return an application service catalog description with pricing options. The broker will match the query with the results and hand that over to the arbitrator for analysis. The arbitrator may request additional information from the Cloud provider, in which case the broker will communicate to the Cloud provider.

The case where the broker “resides” in a Cloud supports a number of users to a number of providers. The arbitrator logic would need to be extended in order to communicate with the broker service.

FIG. 5 depicts a method diagram according to the present invention. As depicted, in step S1, the user configures the broker with any criteria the user may desire in obtaining a Cloud service. Example criteria include (among others) a desired price, a time frame for using the Cloud service, etc. In step S2, a search is conducted for the Cloud service. This search can be performed by the user and/or by the broker on behalf of the user. In the case of the latter, the user will submit a request to the broker. In either event, the search can include a search of a catalog of Cloud service providers. In step S3, results of the search. The results will typically identify a set of Cloud service providers capable of providing the Cloud service based upon the criteria established by the user. Along these lines, the search results can correlate the set of Cloud service providers with corresponding pricing plans, which themselves can each comprise a first price for peak time usage of the Cloud service, and a second price for off-peak time usage of the Cloud service.

In step S4, the broker will analyze the result/data in an attempt to filter out any results that fail to meet the user's criteria (or at least highlight those results to do) to yield filtered/analyzed results. These analyzed results can be presented to the user in step S5. These results can be displayed to be prioritized for the user so, for example, that the closest matches are displayed first (i.e., prioritized higher) in a results list. In step S6, it is determined whether a selection of a specific Cloud service provider is made. Such a selection can be made automatically by the broker (e.g., based upon a closest match to the user criteria) or by the user his/herself. If no Cloud service provider could deliver the request Cloud service in a manner that satisfied the user's criteria, the process can end in step S7. If a selection can be made, the broker can communicate with a specific Cloud service provider from the set of Cloud service providers to provide the Cloud service at the desired price in step S8. Such communication can involve the broker in an arrangement (e.g., an understanding, an agreement, a contract, etc.) between the user and the specific Cloud service provider to provide the Cloud service. The arrangement can include a pricing plan for the provider to provide the Cloud service, and a charging plan for the user to pay for the Cloud service.

While shown and described herein as a Cloud service brokering solution, it is understood that the invention further provides various alternative embodiments. For example, in one embodiment, the invention provides a computer-readable/usable medium that includes computer program code to enable a computer infrastructure to provide Cloud service brokering functionality as discussed herein. To this extent, the computer-readable/usable medium includes program code that implements each of the various processes of the invention. It is understood that the terms computer-readable medium or computer-usable medium comprise one or more of any type of physical embodiment of the program code. In particular, the computer-readable/usable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process of the invention on a subscription, advertising, and/or fee basis. That is, a service provider, such as a Solution Integrator, could offer to provide Cloud service brokering functionality. In this case, the service provider can create, maintain, support, etc., a computer infrastructure, such as computer system 12 (FIG. 1) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing Cloud service brokering functionality. In this case, a computer infrastructure, such as computer system 12 (FIG. 1), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A method for brokering Cloud services within a Cloud computing environment including a network connected cloud computing node having a memory unit and one or more processing units configured to execute computer system instructions, comprising:
receiving a request for a Cloud service from a user, wherein the user initiates the request to the network connected cloud computing node;
identifying a set of Cloud service providers capable of providing the Cloud service based upon criteria established by the user, the criteria comprising a desired price for obtaining the Cloud service, and wherein the set of Cloud service providers capable of providing the Cloud service is continuously updated;
presenting the set of Cloud service providers capable of providing the Cloud service to the user via a display device configured to display the set of Cloud providers capable of providing the Cloud service along with an associated pricing plan for obtaining the Cloud service;
communicating with a specific Cloud service provider from the set of Cloud service providers to provide the Cloud service at the desired price; and
selecting the specific Cloud service provider by the user via the display device.

2. (canceled)

3. The method of claim 1, the identifying comprising:
searching a catalogue of Cloud service providers; and
receiving search results that identify the set of Cloud service providers.

4. The method of claim 3, the search results correlating the set of Cloud service providers with corresponding pricing plans.

5. The method of claim 4, each of the pricing plans comprising a first price for peak time usage of the Cloud service, and a second price for off-peak time usage of the Cloud service.

6. (canceled)

7. The method of claim 1, the communicating comprising brokering an arrangement between the user and the specific Cloud service provider to provide the Cloud service, the arrangement comprising a pricing plan for the provider to provide the Cloud service, and a charging plan for the user to pay for the Cloud service.

8. A system for brokering Cloud services within a Cloud computing environment, comprising:
a memory medium comprising instructions;
a bus coupled to the memory medium;
a processor coupled to the bus that when executing the instructions causes the system to:
receive a request for a Cloud service from a user;
identify a set of Cloud service providers capable of providing the Cloud service based upon criteria established by the user, the criteria comprising a desired price for obtaining the Cloud service, and wherein the set of Cloud service providers capable of providing the Cloud service is continuously updated;
present the set of Cloud service providers capable of providing the Cloud service to the user via a display device configured to display the set of Cloud providers capable of providing the Cloud service along with an associated pricing plan for obtaining the Cloud service;
communicate with a specific Cloud service provider from the set of Cloud service providers to provide the Cloud service at the desired price; and
select the specific Cloud service provider by the user via the display device.

9. (canceled)

10. The system of claim 8, the system further being caused to
search a catalogue of Cloud service providers; and
receive search results that identify the set of Cloud service providers.

11. The system of claim 10, the search results correlating the set of Cloud service providers with corresponding pricing plans.

12. The system of claim 11, each of the pricing plans comprising a first price for peak time usage of the Cloud service, and a second price for off-peak time usage of the Cloud service.

13. (canceled)

14. The system of claim 8, the system further being caused to broker an arrangement between the user and the specific Cloud service provider to provide the Cloud service.

15. A non-transitory computer readable medium containing a program product for brokering Cloud services within a Cloud computing environment, the computer readable medium comprising program code for causing a computer to:
receive a request for a Cloud service from a user;
identify a set of Cloud service providers capable of providing the Cloud service based upon criteria established by the user, the criteria comprising a desired price for obtaining the Cloud service;
communicate with a specific Cloud service provider from the set of Cloud service providers to provide the Cloud service at the desired price, and wherein the set of Cloud service providers capable of providing the Cloud service is continuously updated;
present the set of Cloud service providers capable of providing the Cloud service to the user via a display device configured to display the set of Cloud providers capable of providing the Cloud service along with an associated pricing plan for obtaining the Cloud service; and
select the specific Cloud service provider by the user via the display device.

16. (canceled)

17. The non-transitory computer readable medium containing the program product of claim 15, the computer readable medium further comprising program code for causing the computer to:
search a catalogue of Cloud service providers; and
receive search results that identify the set of Cloud service providers.

18. The non-transitory computer readable medium containing the program product of claim 17, the search results correlating the set of Cloud service providers with corresponding pricing plans.

19. The non-transitory computer readable medium containing the program product 18, each of the pricing plans comprising a first price for peak time usage of the Cloud service, and a second price for off-peak time usage of the Cloud service.

20. (canceled)

21. The non-transitory computer readable medium containing the program product of claim 15, the computer readable medium further comprising program code for causing the computer to broker an arrangement between the user and the specific Cloud service provider to provide the Cloud service.

22. A method for deploying a system for brokering Cloud services within a Cloud computing environment, comprising:
providing a computer infrastructure including a network connected cloud computing node having a memory unit and one or more processing units configured to execute computer system instructions to:
receive a request for a Cloud service from a user, wherein the user initiates the request to the network connected cloud computing node;
identify a set of Cloud service providers capable of providing the Cloud service based upon criteria established by the user, the criteria comprising a desired price for obtaining the Cloud service, and wherein the set of Cloud service providers capable of providing the Cloud service is continuously updated;
present the set of Cloud service providers capable of providing the Cloud service to the user via a display device configured to display the set of Cloud providers capable of providing the Cloud service along with an associated pricing plan for obtaining the Cloud service;
communicate with a specific Cloud service provider from the set of Cloud service providers to provide the Cloud service at the desired price; and
select the specific Cloud service provider by the user via the display device.
